(19) United States
(12) Patent Application Publication
(10) Pub. No.: US 2006/0221200 A1
(43) Pub. Date: Oct. 5, 2006

(54) Display device and portable imaging device

(75) Inventors: Yasushi Kusaka, Mishima-gun (JP); Takuya Kishimoto, Sakai-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/358,288

(22) Filed: Feb. 21, 2006

(30) Foreign Application Priority Data
Mar. 15, 2005 (JP) 2005-72709

(51) Int. Cl. H04N 5/228; H04N 5/225

(52) U.S. Cl. 348/222.1; 348/376

(57) ABSTRACT

A display device having a display unit that is equipped with a display element having pixel arrangement conforming to delta arrangement and that is configured to indicate display data including non-image information and image information. The display device further includes a display controller configured to divide display data indicated by one-time screen display into an odd-numbered field and an even-numbered field, and to superimpose the non-image information with the image information at different timing between the odd-numbered field and the even-numbered field for indication of the superimposed information on the display unit.

### CROSS-REFERENCE TO RELATED APPLICATION

This application is based on Japanese Patent Application No. 2005-72709 filed in Japan on Mar. 15, 2005, the entire content of which is hereby incorporated by reference.

### BACKGROUND OF THE INVENTION

1. Field of the Invention

The present invention relates to a display device and a portable imaging device, more particularly, to a display device and a portable imaging device capable of indicating non-image information, such as characters, symbols and codes.

2. Description of the Related Art

Regarding a color liquid crystal panel being used as a display element for a portable imaging device that mainly takes and displays images, such as a digital camera or a camcorder, a panel having pixel arrangement referred to as delta arrangement in which pixels having the same color on even-numbered lines and odd-numbered lines are deviated mutually by 1.5 pixels is used frequently. FIG. 9(a) shows pixel arrangement conforming to delta arrangement, FIG. 9(b) shows stripe arrangement being used for ordinary liquid crystal television sets and PC monitors, and FIG. 9(c) is a schematic view showing pixel arrangement conforming to mosaic arrangement. R, G and B in the figures represent pixels indicating red, green and blue, respectively.

Generally speaking, a portable imaging device is required to be compact and lightweight for its portability. For this reason, a display device that is mountable thereon is limited in size. Hence, a display device being compact in size and high in image quality is required.

In comparison with liquid crystal panels having stripe arrangement and mosaic arrangement, a liquid crystal panel having delta arrangement is advantageous in that smooth image quality having high apparent resolution without fixed color patterns is obtained using less number of pixels. On the other hand, because the pixels are arranged so as to be deviated obliquely, the liquid crystal panel is disadvantageous in that it has low color reproducibility for thin vertical and horizontal straight lines. For this reason, when the so-called OSD (On Screen Display) is carried out for characters, symbols and codes in data and the like, such as dates and countdown frame numbers, in the liquid crystal panel having delta arrangement, false red or green coloring (false coloring) occurs around the OSD. The false coloring becomes significant around thin lines and straight lines, in particular.

For example, when a black character is displayed against a white background as shown in FIG. 10(a), the background appears white as a whole because R, G and B pixels are lit uniformly. However, for example, when a triangle 901 locally enclosed by broken lines shown in FIG. 10(a) is considered, only the R pixel 901R among the R pixel 901R, G pixel 901G and B pixel 901B in the triangle remains lit. Hence, the fringes of “A” written in black thin lines against the white background are susceptible to false red coloring.

For the purpose of preventing this problem, various methods have been carried out conventionally to make false coloring less noticeable. For example, in a method shown in FIG. 10(b), the thicknesses of the lines of the characters and symbols being used for the OSD are made sufficiently larger than the pixel pitch. In another method, the designs of the characters and symbols being used for the OSD are changed so that straight lines are not used. In still another method, an intermediate color, such as gray, is used for the background of the OSD display portion.

However, because the method in which the thicknesses of the lines of characters and symbols can be made larger is limitedly used for only Japanese kana characters, simple symbols and the like, the method is low in versatility and degrades design and has many limitations, such as the non-use of outline characters on a colored background. In addition, the method in which design is changed so as not to include straight lines is also low in versatility and degrades design. Furthermore, the method in which an intermediate color, such as gray, is used in the background of the OSD causes a serious problem of making the image originally located at the portion invisible.

Moreover, not as a method for a liquid crystal panel having delta arrangement, but as a method for preventing image quality deterioration due to the aliasing noise of the OSD display at the time of interlacing a digital broadcast, a method for reducing flickering in the OSD display has been proposed. In this method, an interlace signal is converted into a progressive signal, and image scaling, OSD synthesis, etc. are carried out, and then the progressive signal is reconverted into the interlace signal while filtering is performed, whereby flickering is reduced. Besides, another method has also been proposed in which a sync signal having a field rate having an odd multiple of the field rate of the ordinary interlace signal is generated, an OSD signal is generated in synchronization with the sync signal, and the image signal is synthesized with the OSD signal.

However, in all of the methods proposed conventionally, very complicated signal processing is necessary or a high-speed clock is required. Hence, these methods are not applicable to portable imaging devices that have only low-performance processing circuits. In addition, these methods are not applicable easily to liquid crystal panels having delta arrangement. Furthermore, because these methods are very high in cost, the application of these methods to portable imaging devices is not realistic.

### SUMMARY OF THE INVENTION

A main object of the present invention is to provide a display device equipped with a display element having pixel arrangement conforming to delta arrangement and capable of reducing false coloring around characters and symbols being used for OSDs.

Another object of the present invention is to provide a display device equipped with a display element having pixel arrangement conforming to delta arrangement and capable of preventing false coloring without changing the thicknesses and designs of characters and symbols, the color of the background, etc. being used for OSDs.

The objects of the present invention are attained by providing a display device comprising:
a display unit that is equipped with a display element having pixel arrangement conforming to delta arrangement, and that is configured to indicate display data including non-image information and image information; and
a display controller configured to divide display data indicated by one-time screen display into an odd-numbered field and an even-numbered field, and to superimpose the non-image information with the image information at different timing between the odd-numbered field and the even-numbered field for indication of the superimposed information on the display unit.

The objects of the present invention are also attained by providing a display device comprising:
a display unit that is equipped with a display element having pixel arrangement conforming to delta arrangement, and that is configured to indicate display data including non-image information and image information;
a non-image information generator that generates the non-image information;
an image information generator that generates the image information; and
a display controller configured to divide display data indicated by one-time screen display into an odd-numbered field and an even-numbered field, and to synthesize the non-image information generated in the non-image information generator with the image information generated in the image information generator at different timing between the odd-numbered field and the even-numbered field for indication of the synthesized information on the display unit.

These and other objects, advantages and features of the invention will become apparent from the following description thereof taken in conjunction with the accompanying drawings, which illustrate specific embodiments of the invention.

### BRIEF DESCRIPTION OF DRAWINGS

These and other objects, advantages and features of the invention will become apparent from the following description thereof taken in conjunction with the accompanying drawings in which:

FIG. 1(a) is a schematic external front view of a digital camera serving as an display device according to the present invention;

FIG. 1(b) is a schematic external rear view of the digital camera serving as the display device according to the present invention;

FIG. 2 is a circuit block diagram of the digital camera serving as the display device according to the present invention;

FIG. 3(a) is a schematic view showing a screen display conforming to the NTSC standard;

FIG. 3(b) is a timing chart showing the display operation conforming to the NTSC standard;

FIG. 4(a) is a schematic view showing a screen display on the display device according to the present invention;

FIG. 4(b) is a timing chart showing the display operation of the display device according to the present invention;

FIG. 5(a) is a schematic display view of an odd-numbered field according to a first embodiment of the OSD of the present invention;

FIG. 5(b) is a schematic display view of an even-numbered field according to the first embodiment of the OSD of the present invention;

FIG. 6(a) is a circuit block diagram that realizes the OSDs shown in FIGS. 5(a) and 5(b);

FIG. 6(b) is a timing chart that realizes the OSDs shown in FIGS. 5(a) and 5(b);

FIG. 7(a) is a schematic display view of an odd-numbered field according to a second embodiment of the OSD of the present invention;

FIG. 7(b) is a schematic display view of an even-numbered field according to the second embodiment of the OSD of the present invention;

FIG. 8(a) is a circuit block diagram that realizes the OSDs shown in FIGS. 7(a) and 7(b);

FIG. 8(b) is a timing chart that realizes the OSDs shown in FIGS. 7(a) and 7(b);

FIG. 8(c) is a magnified view of the portion in which the OSD is superimposed in the even-numbered field shown in FIG. 8(b);

FIG. 9(a) is a schematic view showing pixel arrangement conforming to delta arrangement in the conventional display element;

FIG. 9(b) is a schematic view showing pixel arrangement conforming to vertical stripe arrangement in the conventional display element;

FIG. 9(c) is a schematic view showing pixel arrangement conforming to mosaic arrangement in the conventional display element;

FIG. 10(a) is a schematic view showing an ordinary OSD in the conventional display device; and

FIG. 10(b) is a schematic view showing an OSD in the conventional display device, the thicknesses of the lines of the characters for the OSD being made larger.

### DESCRIPTION OF THE PREFERRED EMBODIMENTS

Embodiments of the present invention will be described below on the basis of the drawings.

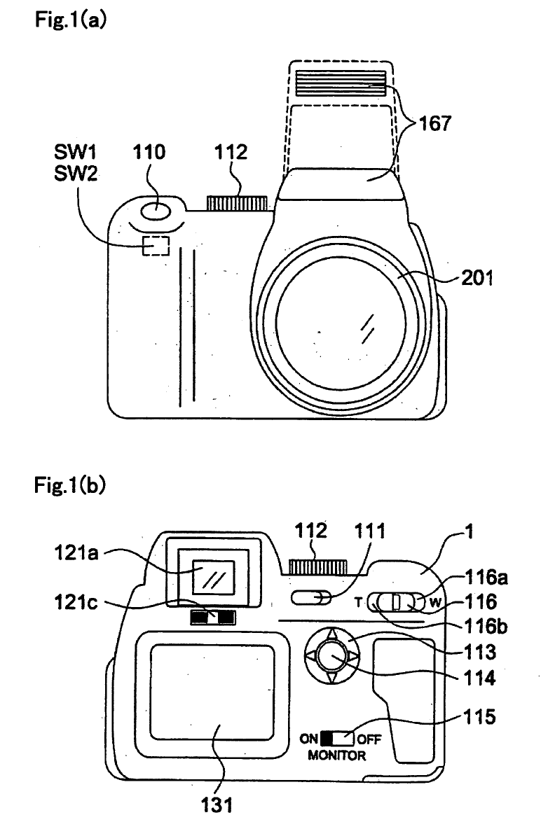

FIG. 1(a) is a schematic external front view of a digital camera 1 that functions as a portable imaging device on which a display device according to the present invention is mounted. FIG. 1(b) is a schematic external rear view of the digital camera 1.

As shown in FIG. 1(a), a lens device 201 is provided at the front of the digital camera 1.

A release button 110 is provided on the upper face of the digital camera 1. In addition, under the release button 110 and inside the digital camera 1, two-stage switches, i.e., an AF switch SW1 and a release switch SW2, are provided. The AF switch SW1 and the release switch SW2 are configured to function in response to the first-stage pressing operation and the second-stage pressing operation of the release button 110, respectively.

In addition, a mode setting dial 112 that is used to set the operation modes of the camera is provided on the upper face of the digital camera 1. As the operation modes of the camera, “camera mode” in which still images are taken, “moving image mode” in which moving images are taken, “voice recorder mode” in which sound is recorded, “reproduction mode” in which images and sound are reproduced, etc. are available. Furthermore, a pop-up flash unit 167 is provided on the upper face of the digital camera 1.

As shown in FIG. 1(b), a rear monitor 131 formed of a liquid crystal display or the like, the eyepiece 121a of an electronic viewfinder (EVF) 121, and an eyepiece detector 121c that is disposed near the eyepiece 121a and detects that the user has looked into the eyepiece 121a are provided on the rear face of the digital camera 1. The eyepiece detector 121c is configured to detect that the user has looked into the eyepiece 121a, for example, by projecting invisible light, such as infrared light, from a projector and by receiving the infrared light projected and reflected from the face of the user at a light-receiving device disposed in a light receiver distanced by base-line length.

In addition, on the rear face of the digital camera 1, various operation units, such as a main switch 111 serving as the power switch of the camera, a jog dial 113 that has switches in four directions, up, down, left and right, and is used for various settings and the like of camera operations, a determination switch 114 that determines the settings of the jog dial 113 and the like, a rear monitor setting switch 115 that carries out the ON/OFF settings of the rear monitor 131, and a zoom switch 116 that carries out zooming for the imaging optical system, are disposed.

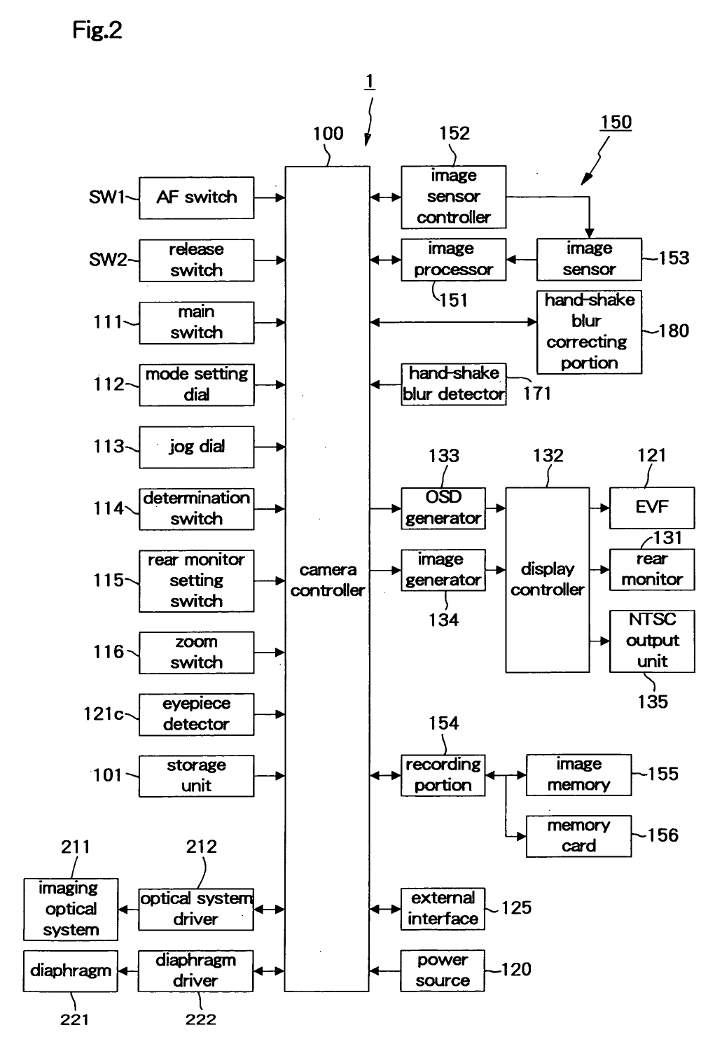

FIG. 2 is a circuit block diagram of the digital camera 1 that functions as the display device according to the present invention. In the figure, the same units as those shown in FIGS. 1(a) and 1(b) are designated by the same numerals.

A camera controller 100 serving as the controller of the digital camera 1 comprises a CPU (central processing unit), work memory, etc. (these are not shown). The controller 100 reads programs stored in a storage unit 101 to the work memory and centrally controls all the units of the digital camera 1 according to the programs.

Furthermore, after receiving inputs from the main switch 111, the mode setting dial 112, the jog dial 113, the determination switch 114, the rear monitor setting switch 115, the zoom switch 116, the AF switch SW1, the release switch SW2, the eyepiece detector 121c, etc., the camera controller 100 controls all the units of the digital camera 1. The camera controller 100 also controls a power source 120 to supply power to all the units of the camera. Moreover, the camera controller 100 carries out communication, such as image data transfer, with a personal computer and a printer (these are not shown) via an external interface (I/F) 125, such as a USB (Universal Serial Bus).

Besides, the camera controller 100 controls the image-taking operation of an image sensor 153 via an image sensor controller 152, processes the image taken by the image sensor 153 via an image processor 151, records the image once in an image memory 155 via a recording portion 154, and then finally records the image in a memory card 156. The combination of the image processor 151, the image sensor controller 152 and the image sensor 153 is referred to as an imaging unit 150. Further, the camera controller 100 controls the AF operation of an imaging optical system 211 via an optical system driver 212 and also controls a diaphragm 221 via a diaphragm driver 222 on the basis of focus information and exposure information obtained from the image output from the imaging unit 150.

In addition, the camera controller 100 displays the image taken using the image sensor 153 and processed using the image processor 151 as a live view image on the electronic viewfinder (EVF) 121 or the rear monitor 131 or on both of them via an image generator 134 and a display controller 132 according to the setting at the rear monitor setting switch 115. The camera controller 100 also displays the image recorded in the image memory 155 as an after view image on the rear monitor 131 via the image generator 134 and the display controller 132. Furthermore, the camera controller 100 displays the image recorded in the memory card 156 as a reproduced image on the rear monitor 131 via the image generator 134 and the display controller 132. In other words, the electronic viewfinder (EVF) 121 and the rear monitor 131 function as display devices according to the present invention, and the camera controller 100 and the display controller 132 function as display controllers according to the present invention. Still further, in this embodiment, the rear monitor 131 and the EVF 121 are formed of a liquid crystal display element having delta arrangement.

Additionally, the camera controller 100 transmits an OSD signal to the display controller 132 via an OSD generator 133 using the OSD information stored beforehand in the storage unit 101 depending on the setting states of the various units and operation units of the camera. The display controller 132 synthesizes the OSD signal from the OSD generator 133 and the image signal from the image generator 134, and displays the obtained image on the EVF 121 or the rear monitor 131 or on both of them. The OSD information represents non-image information according to the present invention. The non-image information includes information indicating icons, such as pictographic symbols and pictographic characters, and circular and rectangular line drawings, in addition to the characters, symbols and codes corresponding to the known character codes.

Furthermore, the camera controller 100 outputs the live view image taken using the image sensor 153 and processed using the image processor 151, the after view image recorded in the image memory 155 and the reproduced image recorded in the memory card 156 as NTSC signals conforming to the National Television Standard Committee (NTSC), for example, to an NTSC output unit 135 via the image generator 134 and the display controller 132. The signals are displayed on a television set or the like connected externally.

The live view image, the after view image and the reproduced image are displayed according to the NTSC display being used for the display on ordinary television sets and the like, that is, displayed by interlace scanning so as to conform to the signal output to the NTSC output unit 135. In other words, the display data being displayed by one-time screen display is divided into an odd-numbered field and an even-numbered field, and the image data in each field is displayed by interlace scanning every 1/60 second.

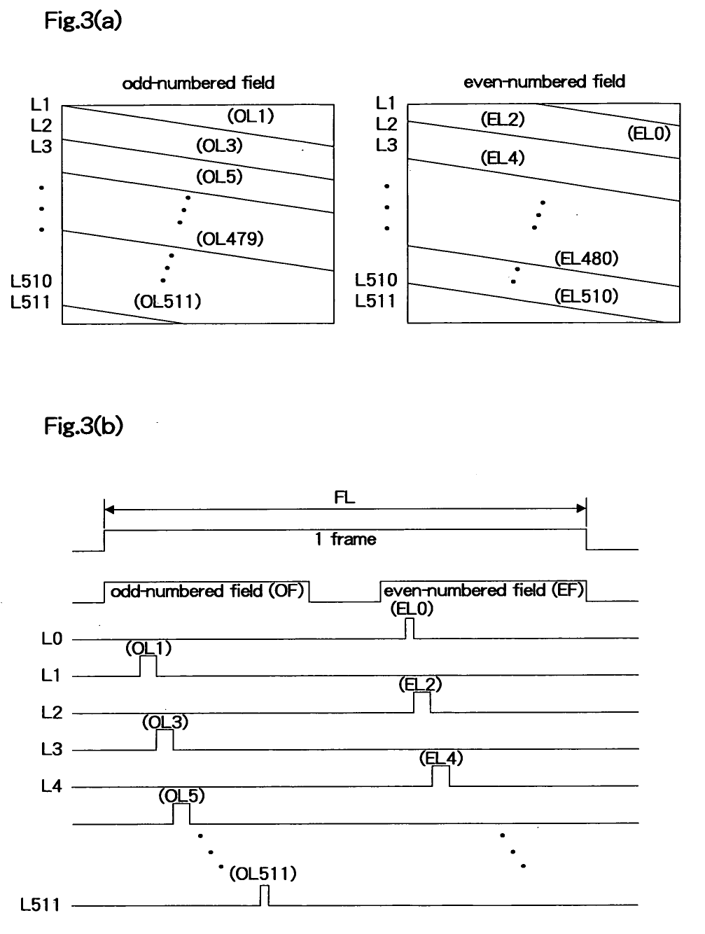

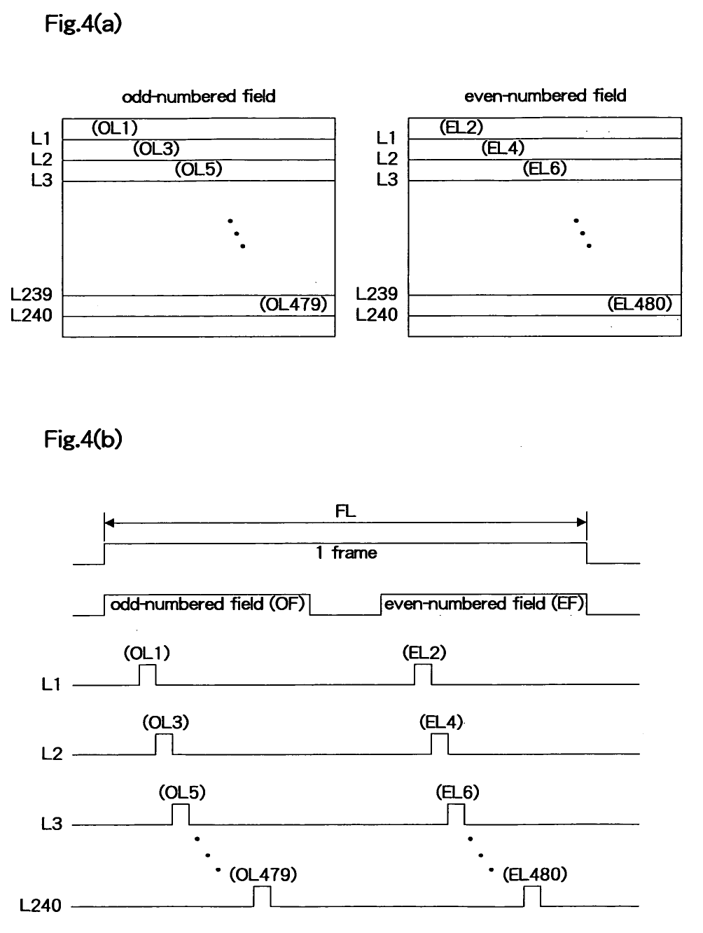

In the NTSC standard, the number of pixel lines in the vertical direction is 512. However, in the liquid crystal displays being used for the EVF 121 and the rear monitor 131, the number of pixel lines in the vertical direction is approximately 240, about half the number of pixel lines in the NTSC standard. Hence, on the EVF 121 and the rear monitor 131, instead of the original interlaced display, the lines, for example, from the first line to the 479th line, in the odd-numbered field of the NTSC signal are displayed using all the 240 lines. Similarly, the lines, for example, from the second line to the 480th line, in the odd-numbered field are displayed using all the 240 lines. In other words, apparent display at 60 frames/second is generally used. This relationship will be explained using FIGS. 3(a) and 3(b) and FIGS. 4(a) and 4(b).

FIG. 3(a) is a schematic view showing a screen display conforming to the NTSC standard. In an odd-numbered field of image data, image display is performed by interlace scanning in which every other lines are scanned, in such a way that the first-line image (OL1) of the image data is displayed on the first line L1 of the screen, that the third-line image (OL3) of the image data is displayed on the third line L3, and so on. At the last line, the 511th line, the display ends at the center of the screen in the horizontal direction. In an even-numbered field of the image data, image display is performed so as to fill the spaces between the odd-numbered field lines, in such a way that the second-line image (EL2) of the image data is displayed on the second line L2, that the fourth-line image (EL4) of the image data is displayed on the fourth line L4, and so on until the last line (the 510th line) is reached. At the first line (the 0th line), the display starts at the center of the screen in the horizontal direction.

FIG. 3(b) is a timing chart showing the display operation. During the period of one frame FL, in the odd-numbered field reading OF, the display data is transmitted to only the odd-numbered lines of the screen, such as the first line L1 and the third line L3. In the even-numbered field reading EF, the display data is transmitted to only the even-numbered lines, such as the second line L2 and the fourth line L4.

On the other hand, FIG. 4(a) is a schematic view showing a screen display according to the present invention. In an odd-numbered field of image data, image display is performed without interlace scanning, in such a way that the first-line image (OL1) of the image data is displayed on the first line L1 of the screen, that the third-line image (OL3) of the image data is displayed on the second line L2, and so on. The 479th-line image (OL479) of the image data is displayed on the 240th line L240. The lines from the 481st line to the 511th line are ignored in this embodiment. In an even-numbered field of the image data, image display is performed without interlace scanning, in such a way that the second-line image (EL2) of the image data is displayed on the first line L1, that the fourth-line image (EL4) of the image data is displayed on the second line L2, and so on. The 480th-line image (EL480) of the image data is displayed on the 240th line L240. The lines from the 482nd line to the 510th line are ignored in this embodiment.

FIG. 4(b) is a timing chart showing the display operation. During the period of one frame, in both the odd-numbered field reading OF and the even-numbered field reading EF, the display data is transmitted to all the lines from the first line L1 to the 240th line L240.

In other words, in the screen display according to the NTSC standard, image display is performed at all the lines of the screen during the period of one frame (= 1/30 second). However, in the screen display according to the present invention, image display is performed at all the lines of the screen during the period of one field (= 1/60 second).

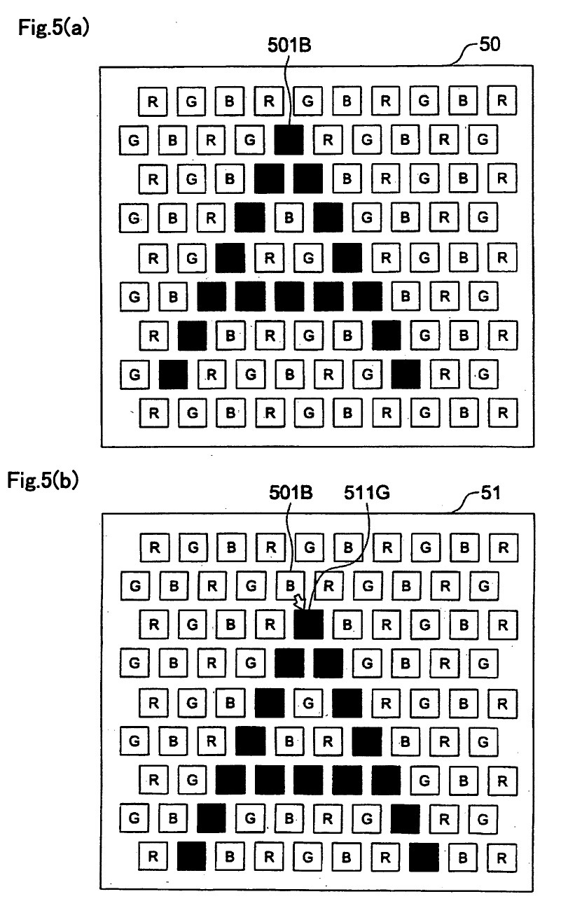

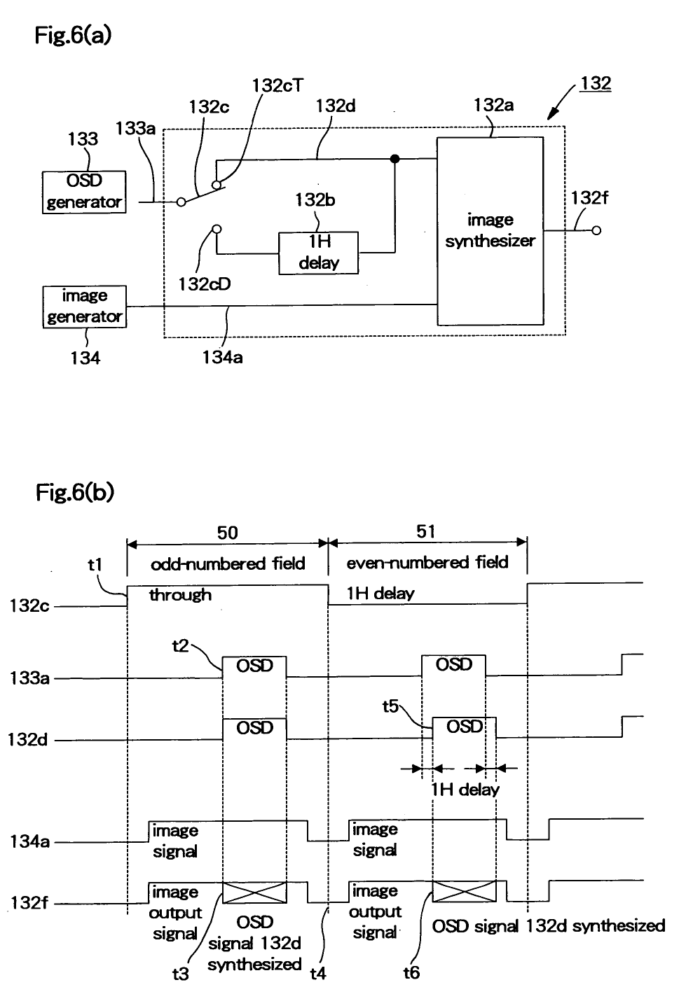

Next, a first embodiment of an OSD for non-image information, such as characters and symbols, in the digital camera 1 will be explained using FIGS. 5(a) and 5(b) and FIGS. 6(a) and 6(b). FIG. 5(a) is a schematic display-view of an odd-numbered field according to the first embodiment of the OSD. FIG. 5(b) is a schematic display view of an even-numbered field according to the first embodiment of the OSD. FIG. 6(a) is a circuit block diagram showing the internal configuration of the display controller 132 that realizes the OSDs shown in FIGS. 5(a) and 5(b). FIG. 6(b) is a timing chart showing the operations of various units constituting the display controller 132 that realizes the OSDs shown in FIGS. 5(a) and 5(b).

In FIG. 5(a), a character “A” is formed in which the B pixel 501B, the fifth pixel from the left on the second line from above, is used as the vertex thereof. In FIG. 5(b), a character “A” is formed in which the G pixel 511G, the fifth pixel from the left on the third line from above, is used as the vertex thereof. In other words, in comparison between FIGS. 5(a) and 5(b), the OSD is deviated by one horizontal line in the vertical direction and by 0.5 pixels in the horizontal direction, as indicated by an arrow in FIG. 5(b). When these two OSDs are superimposed with image information alternately every 1/60 second and displayed, the peripheries of the lines in the OSDs become slightly blurry owing to the afterimage effect of the human eye. In addition, the false colors appearing in the two OSDs differ from each other and become less noticeable.

The two OSDs are generated as shown in FIGS. 6(a) and 6(b). First, when the odd-numbered field 50 of the image data is generated, the switch 132c is turned to the through side 132cT (at t1). The OSD signal 133a generated in the OSD generator 133 is directly input as an OSD signal 132d to an image synthesizer 132a (at t2). In the image synthesizer 132a, the OSD signal 132d is synthesized with the image signal 134a generated in the image generator 134 and then output as an image output 132f (at t3). This is the OSD shown in FIG. 5(a).

After the image synthesis in the odd-numbered field 50 is completed (at t4), the switch 132c is turned to the 1H delay side 132cD for the purpose of generating the even-numbered field 51 of the image data. The OSD signal 133a generated in the OSD generator 133 is input to a 1H delay 132b formed of a delay device, such as a CCD, and then input as the OSD signal 132d delayed by one line to the image synthesizer 132a (at t5). In the image synthesizer 132a, the OSD signal 132d is synthesized with the image signal 134a generated in the image generator 134 and then output as the image output 132f (at t6). This is the OSD shown in FIG. 5(b). When the OSD for one horizontal line extends beyond one field period, the extending part of the OSD is ignored.

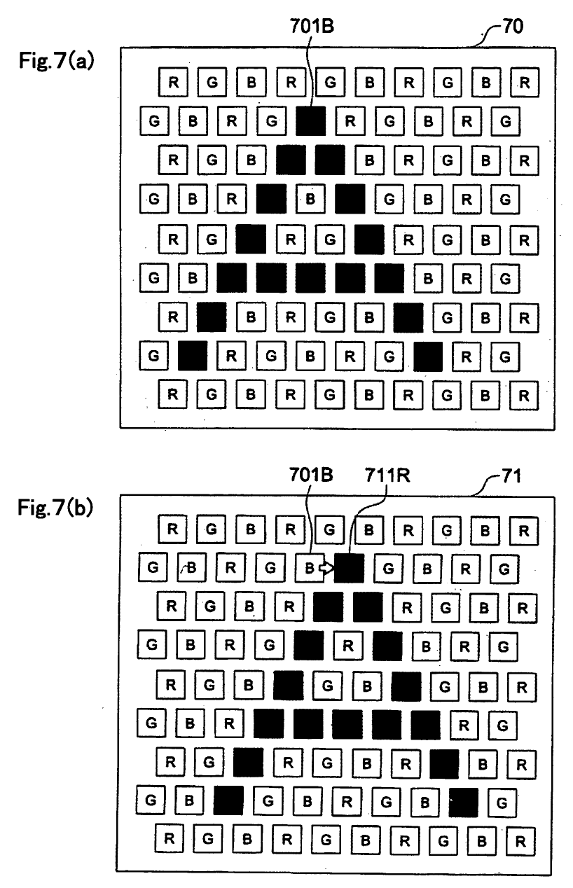

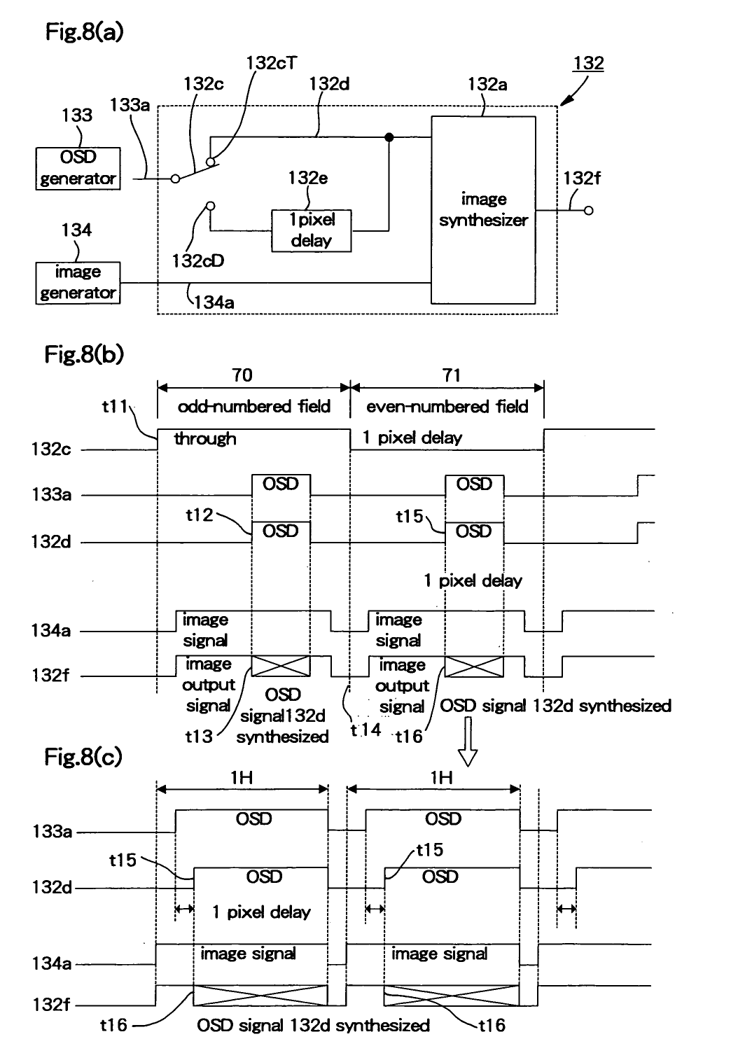

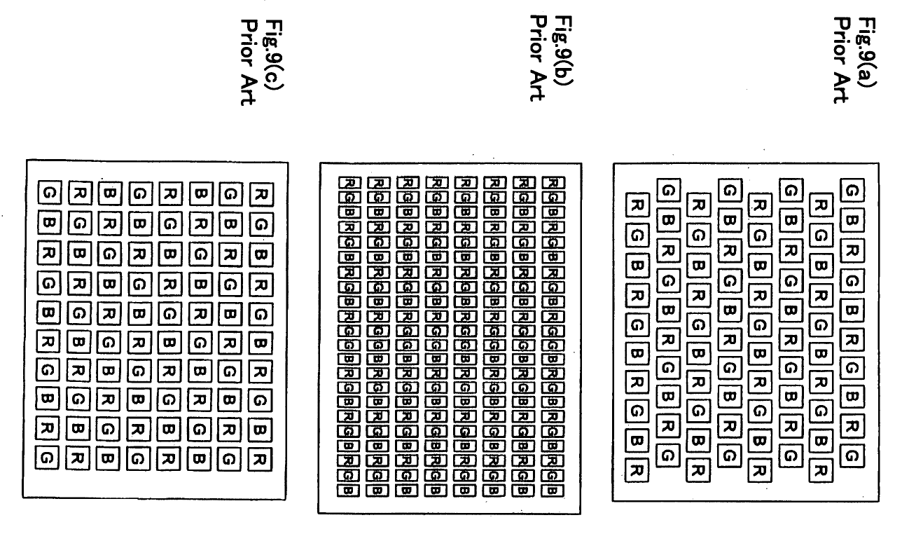

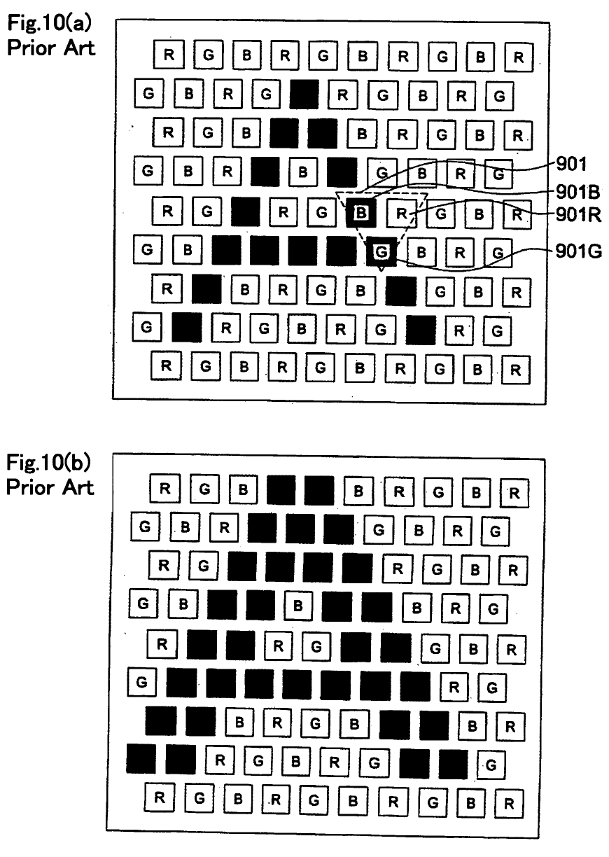

Next, a second embodiment of an OSD for non-image information in the digital camera 1 will be explained using FIGS. 7(a) and 7(b) and FIGS. 8(a) and 8(b). FIG. 7(a) is a schematic display view of an odd-numbered field according to the second embodiment of the OSD. FIG. 7(b) is a schematic display view of an even-numbered field according to the second embodiment of the OSD. FIG. 8(a) is a circuit block diagram showing the internal configuration of the display controller 132 that realizes the OSDs shown in FIGS. 7(a) and 7(b). FIG. 8(b) is a timing chart showing the operations of various units constituting the display controller 132 that realizes the OSDs shown in FIGS. 7(a) and 7 (b). FIG. 8 (c) is a magnified view of the portion in which the OSD is superimposed with image information in the even-numbered field shown in FIG. 8(b).

In FIG. 7(a), a character “A” is formed in which the B pixel 701B, the fifth pixel from the left on the second line from above, is used as the vertex thereof. In FIG. 7(b), a character “A” is formed in which the R pixel 711R, the sixth pixel from the left on the second line from above, is used as the vertex thereof. In other words, in comparison between FIGS. 7(a) and 7(b), the OSD is deviated by one pixel in the horizontal direction as indicated by an arrow in FIG. 7 (b). When these two OSDs are superimposed with image information alternately every 1/60 second and displayed, the peripheries of the lines in the OSDs become slightly blurry owing to the afterimage effect of the human eye. In addition, the false colors appearing in the two OSDs differ from each other and become less noticeable.

The two OSDs are generated as shown in FIGS. 8(a) to 8(c). As shown in FIGS. 8(a) and 8(b), first, when the odd-numbered field 70 of the image data is generated, the switch 132c is turned to the through side 132cT (at t11). The OSD signal 133a generated in the OSD generator 133 is directly input as the OSD signal 132d to the image synthesizer 132a (at t12). In the image synthesizer 132a, the OSD signal 132d is synthesized with the image signal 134a generated in the image generator 134 and then output as the image output 132f (at t13). This is the OSD shown in FIG. 7(a).

After the image synthesis in the odd-numbered field 70 is completed (at t14), the switch 132c is turned to the 1 pixel delay side 132cD for the purpose of generating the even-numbered field 71 of the image data. As shown in FIG. 8(c) in detail, the OSD signal 133a generated in the OSD generator 133 is input to a one-pixel delay 132e formed of a delay device, such as a CCD, and then input as the OSD signal 132d delayed by one pixel every horizontal line to the image synthesizer 132a (at t15). In the image synthesizer 132a, the OSD signal 132d is synthesized with the image signal 134a generated in the image generator 134 and then output as the image output 132f (at t16). This is the OSD shown in FIG. 7(b). When the OSD delayed by one pixel extends beyond the 1H period, the extending part of the OSD is ignored.

As described above, according to this embodiment, when OSD information serving as non-image information is displayed on the display device comprising a liquid crystal display element having delta arrangement, the OSD information is directly superimposed with image information in the odd-numbered field of the image display, and only the OSD information is deviated in the vertical or horizontal direction in the even-numbered field and superimposed with the image information. Hence, false coloring occurring around the OSD can be reduced, and the quality of the display can be improved.

Because the display is performed while having a deviation between the position of the OSD in the odd-numbered field and the position of the OSD in the even-numbered field, it is recognized that the OSD shakes slightly if it is observed carefully, as a matter of course. However, the shaking is very small to the extent that it cannot be detected if it is not observed carefully with a magnifying glass or the like. On the other hand, the effect of reducing false coloring is very significant. Therefore, the value of the present invention is very high.

Although the present invention has been fully described by way of examples with reference to the accompanying drawings, it is to be noted here that various changes and modifications will be apparent to those skilled in the art. Therefore, unless otherwise such changes and modifications depart from the scope of the present invention, they should be construed as being included therein.

What is claimed is:

1. A display device comprising:
a display unit that is equipped with a display element having pixel arrangement conforming to delta arrangement, and that is configured to indicate display data including non-image information and image information; and
a display controller configured to divide display data indicated by one-time screen display into an odd-numbered field and an even-numbered field, and to superimpose the non-image information with the image information at different timing between the odd-numbered field and the even-numbered field for indication of the superimposed information on the display unit.

2. The display device as claimed in claim 1,
wherein the non-image information includes characters, symbols, codes, pictographic symbols, pictographic characters, and circular or rectangular line drawings.

3. The display device as claimed in claim 1,
wherein said display controller superimposes the non-image information with the image information while only the non-image information is deviated by one horizontal line in a vertical direction between the odd-numbered field and the even-numbered field.

4. The display device as claimed in claim 1,
wherein said display controller superimposes the non-image information with the image information while only the non-image information is deviated by one pixel in a horizontal direction between the odd-numbered field and the even-numbered field.

5. The display device as claimed in claim 1,
wherein the display controller indicates the display data without performing interlace scanning.

6. The display device as claimed in claim 1,
wherein the device is configured to receive the image information of an object captured by an image taking device and indicate the received image information on the display unit.

7. The display device as claimed in claim 6,
wherein the display device is a rear monitor of a digital camera.

8. The display device as claimed in claim 6,
wherein the display device is an electronic viewfinder of a digital camera.

9. A display device comprising:
a display unit that is equipped with a display element having pixel arrangement conforming to delta arrangement, and that is configured to indicate display data including non-image information and image information;
a non-image information generator that generates the non-image information;
an image information generator that generates the image information; and
a display controller configured to divide display data indicated by one-time screen display into an odd-numbered field and an even-numbered field, and to synthesize the non-image information generated in the non-image information generator with the image information generated in the image information generator at different timing between the odd-numbered field and the even-numbered field for indication of the synthesized information on the display unit.

10. The display device as claimed in claim 9,
wherein the non-image information includes characters, symbols, codes, pictographic symbols, pictographic characters, and circular or rectangular line drawings.

11. The display device as claimed in claim 9,
wherein said display controller synthesizes the non-image information with the image information while only the non-image information is deviated by one horizontal line in a vertical direction between the odd-numbered field and the even-numbered field.

12. The display device as claimed in claim 9,
wherein said display controller synthesizes the non-image information with the image information while only the non-image information is deviated by one pixel in a horizontal direction between the odd-numbered field and the even-numbered field.

13. The display device as claimed in claim 9,
wherein the display controller indicates the display data without performing interlace scanning.

14. The display device as claimed in claim 9,
wherein the image information generator is configured to generate the image information based upon an image of an object captured by an image taking device.

15. A portable image taking device comprising:
an imaging portion configured to capture an image of an object;
a display unit that is equipped with a display element having pixel arrangement conforming to delta arrangement, and that is configured to indicate display data including non-image information and image information;
a non-image information generator that generates the non-image information;
an image information generator that generates the image information; and
a display controller configured to divide display data indicated by one-time screen display into an odd-numbered field and an even-numbered field, and to synthesize the non-image information generated in the non-image information generator with the image information generated in the image information generator at different timing between the odd-numbered field and the even-numbered field for indication of the synthesized information on the display unit.

16. The portable image taking device as claimed in claim 15,
wherein the non-image information includes characters, symbols, codes, pictographic symbols, pictographic characters, and circular or rectangular line drawings.

17. The portable image taking device as claimed in claim 15,
wherein said display controller synthesizes the non-image information with the image information while only the non-image information is deviated by one horizontal line in a vertical direction between the odd-numbered field and the even-numbered field.

18. The portable image taking device as claimed in claim 15,
wherein said display controller synthesizes the non-image information with the image information while only the non-image information is deviated by one pixel in a horizontal direction between the odd-numbered field and the even-numbered field.

19. The portable image taking device as claimed in claim 15,
wherein the display controller indicates the display data without performing interlace scanning.
